(19) United States
(12) Patent Application Publication
(10) Pub. No.: US 2005/0288029 A1
(43) Pub. Date: Dec. 29, 2005

(54) Method and system for determining a data communication frequency plan

(75) Inventor: Krista S. Jacobsen, San Jose, CA (US)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/057,494

(22) Filed: Feb. 14, 2005

Related U.S. Application Data
(60) Provisional application No. 60/582,095, filed on Jun. 23, 2004.

(51) Int. Cl. H04Q 7/20

(52) U.S. Cl. 455/447

(57) ABSTRACT

A method and system for determining a data communication frequency plan. Some exemplary embodiments include an iterative method used in a data communication system, comprising: selecting a target data rate and a target loop length (rate/reach target) from a plurality of rate/reach targets; defining a frequency plan that supports the selected rate/reach target; and aggregating the defined frequency plan into an overall frequency plan. The selecting, defining and aggregating are performed in each of multiple iterations within a cycle. At the end of an iteration the overall frequency plan permits transmission of data at the target data rate stored in the rate/reach target selected in the iteration.

### CROSS-REFERENCE TO RELATED APPLICATIONS

This application is a non-provisional application claiming priority to U.S. Provisional Application Ser. No. 60/582,095 filed on Jun. 23, 2004, entitled “Intelligent Frequency Planner,” which is hereby incorporated by reference.

### BACKGROUND

1. Technical Field

The present subject matter relates to determining a frequency plan for a data communication system.

2. Background Information

Digital subscriber line (DSL) technology has increased in popularity in recent years. But the presence of multiple DSL signals operating on multiple adjacent wires has created significant limitations on the data transfer rates that can be offered to consumers. One of these limitations results from what is known as “crosstalk” between adjacent telecommunication wires. Crosstalk occurs when two wires are in close proximity to each other and the signal from one wire electromagnetically couples to another wire. Two types of crosstalk can occur: near-end crosstalk (NEXT) and far-end crosstalk (FEXT). NEXT is caused by transmissions from transmitters proximate to a victim receiver in a frequency band that overlaps the frequency band used by the receiver. NEXT levels increase with increasing frequency. FEXT is caused when multiple transmitters, located at the opposite end of a telephone line from the victim receiver, transmit simultaneously in a given frequency band. The telephone line between the transmitter and the victim receiver attenuates FEXT, thus making it a less severe impairment than NEXT.

The existing telecommunication infrastructure was designed to support voice communications, which generally take place in the frequency band below 3 Kilohertz (kHz). Telecommunication wires (e.g., copper telephone wires) composed of twisted pairs of wire may be used to connect a telecommunication provider's local exchange facility to a subscriber. The twisted pair is used as the transmission medium to reduce crosstalk between lines that are physically close. By twisting the wires together and transmitting a signal on the wires using balanced circuits (a positive phase of the signal on one wire, a negative phase on the other wire), noise induced on each wire of the pair is reduced significantly at low frequencies when the transmission is differentially amplified at the receiver end of the twisted pair. This allows many twisted pairs to be grouped together in a single wire bundle without significant interactions between them in the frequencies for which the existing telecommunication infrastructure was designed to be used.

However, DSL signals operate at frequencies that may range from the tens of Kilohertz to the tens of Megahertz. At such frequencies, the use of differential-mode transmission on twisted pair lines may not adequately limit crosstalk interference. To address this issue, DSL standards manage crosstalk by specifying which frequency bands may be used in the downstream direction (from the service provider to the subscriber) and in the upstream direction (from the subscriber to the service provider), the power levels that may be transmitted within a band, and other relevant factors that characterize a DSL transmission. The partitioning of the available spectrum into downstream and upstream bands results in what is commonly known as a “frequency plan.” When the downstream and upstream bands of a frequency plan do not overlap in frequency, only FEXT occurs when different transceivers operate within the frequency plan. Because FEXT is typically a less severe impairment than NEXT, use of a common frequency plan is often required for systems that operate within the same wire bundle.

Standardization or regulatory bodies may dictate a frequency plan, but in some circumstances a service provider might have the freedom to configure a new frequency plan. When a service provider has the freedom to choose a frequency plan, it is often the case that the frequency plans defined in various standards do not provide the best performance for the service provider's specific service objectives. For example, a frequency plan defined in a standard might be optimized to support a specific downstream and upstream bit rate combination under specific noise assumptions. If the service provider wishes to provide a different bit rate combination, or if the noise in his network does not match the noise assumed when the frequency plan was derived, then the pre-defined frequency plan is suboptimal for the service provider's needs.

### SUMMARY

The problems noted above are addressed in large part by a method and system for determining a data communication frequency plan. Some exemplary embodiments include an iterative method used in a data communication system, comprising: selecting a target data rate and a target loop length (rate/reach target) from a plurality of rate/reach targets; defining a frequency plan that supports the selected rate/reach target; and aggregating the defined frequency plan into an overall frequency plan. The selecting, defining and aggregating are performed in each of multiple iterations within a cycle. At the end of an iteration the overall frequency plan permits transmission of data at the target data rate stored in the rate/reach target selected in the iteration.

Other exemplary embodiments include a data communication system, comprising a processor, and communication software executing on the processor. The communication software causes the processor to iteratively select a rate/reach target from a plurality of rate/reach targets, and to iteratively define a frequency plan that is incorporated into an overall frequency plan. The overall frequency plan that results at the end of an iteration allows transmission of data at the target data rate stored in the rate/reach target selected within the current iteration.

Yet another embodiment includes a storage medium containing software that can be executed on a processor and that causes the processor to iteratively select a rate/reach target from a plurality of rate/reach targets, define a frequency plan, and aggregate the defined frequency plan into an overall frequency plan. The processor selects, defines and aggregates in each of multiple iterations. At the end of an iteration the overall frequency plan allows data to be transmitted at the target data rate stored in the rate/reach pair selected in the iteration.

### BRIEF DESCRIPTION OF THE DRAWINGS

For a detailed description of some of the embodiments of the invention, reference will now be made to the accompanying drawings in which:

FIG. 1 illustrates an end-to-end DSL installation comprising a frequency planner constructed in accordance with a preferred embodiment of the invention;

FIG. 2 illustrates example frequency bands used by a DSL modem;

FIG. 3 illustrates a frequency planner constructed in accordance with a preferred embodiment of the invention;

FIGS. 4A through 4D illustrate a bandwidth allocation technique; and

FIG. 5 illustrates a preferred method for configuring a DSL frequency plan.

### NOTATION AND NOMENCLATURE

Certain terms are used throughout the following discussion and claims to refer to particular system components. This document does not intend to distinguish between components that differ in name but not function.

In the following discussion and in the claims, the terms “including” and “comprising” are used in an open-ended fashion, and thus should be interpreted to mean “including but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections. Additionally, the term “software” includes any executable code capable of running on a processor, regardless of the media used to store the software. Thus, code stored in non-volatile memory, and sometimes referred to as “embedded firmware,” is included within the definition of software. Further, the term “system” refers to a collection of two or more parts and may be used to refer to a data communication system or a portion of a data communication system.

The term “noise,” as used in this disclosure, is meant to indicate a signal that is largely unrelated to the desired information and interferes with the reception or decoding of a signal comprising desired information. Thus, even though an interfering signal may not be random or spurious in nature, and may in fact contain coherent information, the interfering signal is considered noise if the signal is not the desired signal or information, and it interferes with the desired signal or with decoding of the desired information. Also, the term noise is meant to include both measured and estimated noise.

### DETAILED DESCRIPTION OF THE EMBODIMENTS

The following is a description of the various embodiments of the invention in the context of a Digital Subscriber Line (DSL) communication system. However, it should be noted that the principles described herein are not limited to just DSL communication systems, nor to just twisted-pair communication lines. The apparatus and methods described herein can be applied to numerous other types of communication devices and systems, and to a variety of communication line types comprising different configurations and materials.

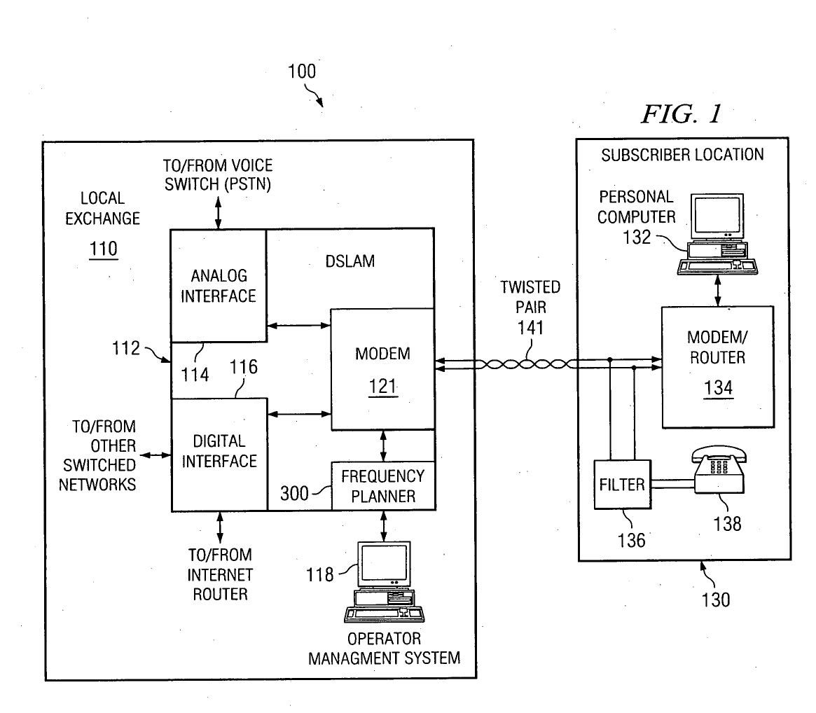

FIG. 1 illustrates a frequency planner 300 configured in accordance with a preferred embodiment of the invention as part of a DSL installation 100. The DSL installation 100 may be divided into two physical locations, the subscriber location 130 and the local exchange 110. The subscriber location 130 may comprise a variety of different physical locations (e.g., a residence or an office building) where DSL service may be desired. The local exchange 110 may comprise a centrally located telecommunications facility that couples to a plurality of geographically proximate subscriber locations. In practice, the local exchange 110 may be a central office, a remote terminal or any other facility in which a service provider can locate equipment. The local exchange 110 may provide connectivity to a variety of communication networks including voice networks (e.g., a public switched telephone network or PSTN) and data networks (e.g., the Internet).

The local exchange 110 and the subscriber location 130 may be coupled to each other by a twisted pair 141. The length of the twisted pair is sometimes referred to as the “reach” of the communication line. The local exchange 110 may comprise a digital subscriber line access multiplexer (DSLAM) 112 comprising a frequency planner 300, an analog interface 114, a digital interface 116, and a modem 121. The frequency planner 300, the analog interface 114 and the digital interface 116 all couple to the modem 121. The DSLAM 112 may couple to other equipment (not shown) within the local exchange 110 via either or both the analog interface 114 and the digital interface 116. The local exchange 110 may also comprise an operator management system 118 coupled to frequency planner 300. Operator management system 118 may be used by an operator to configure frequency planner 300.

The modem 121 within the DSLAM 112 acts as the communications interface to the subscriber location 130, coupling via twisted pair 141 to a DSL modem/router 134 located at the subscriber location 130. In general, there will be multiple twisted pairs from the local exchange to various subscriber locations and even multiple twisted pairs to a common subscriber location. Such collections of twisted pairs may be grouped in a single cable that may sometimes be referred to as a “wire bundle” or “binder.”

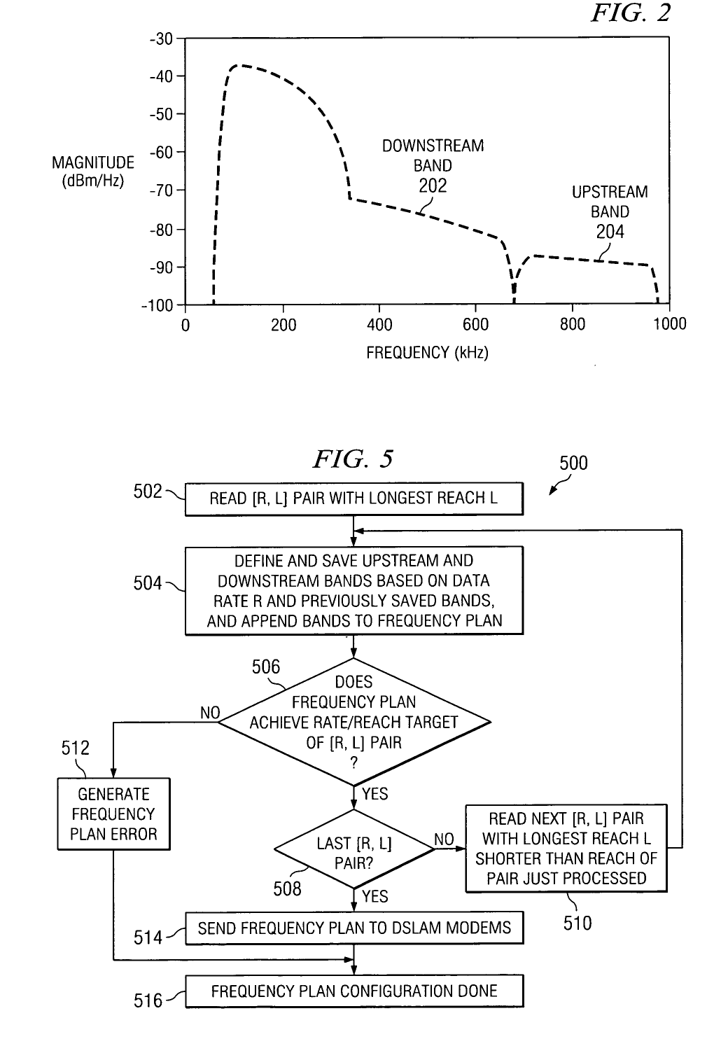

Data received from one or more digital data sources by the digital interface 116 may be transmitted as a modulated signal by the modem 121. Referring to FIG. 2, one or more downstream bands (e.g., downstream band 202) may comprise a modulated signal carrying the transmitted data. The term “downstream” indicates a data flow from the local exchange 110 to the subscriber location 130. An upstream band (e.g., upstream band 204) may comprise data transmitted from the subscriber location 130 to the local exchange 110 as will be described below.

Referring again to FIG. 1, the downstream signal is transmitted over twisted pair 141 and received at the subscriber location 130. The subscriber location 130 may comprise a DSL modem/router 134 which may be coupled to various types of devices (e.g., personal computer 132). Modem/router 134 demodulates received transmissions and reconstructs the digital data. The digital data may be forwarded to a destination device such as personal computer 132, or other devices such as, for example, video on demand devices, video teleconferencing devices, and voice over IP devices. Traditional voice signals may be ignored by the data modem/router 134 and devices such as telephone 138 may be coupled to the twisted pair 141 in parallel with the DSL modem/router 134. Filter 136 may be coupled between twisted pair 141 and telephone 138 to reduce interference with the voice signal by the DSL signal.

Similarly, data originating from a device at the subscriber location (e.g., personal computer 132) may be received by modem/router 134 and transmitted as a modulated signal. Again referring to FIG. 2, one or more “upstream” bands (e.g., upstream band 204) may be defined that comprises a modulated signal carrying the transmitted data. Returning to FIG. 1, the transmission is received and demodulated by modem 121 of DSLAM 112. The digital data is then sent to digital interface 116, where it may be distributed to one or more destinations. Voice communication signals may be routed by modem 121 to analog interface 114. The analog signals may then be sent to a voice switch (not shown) coupled to a PSTN.

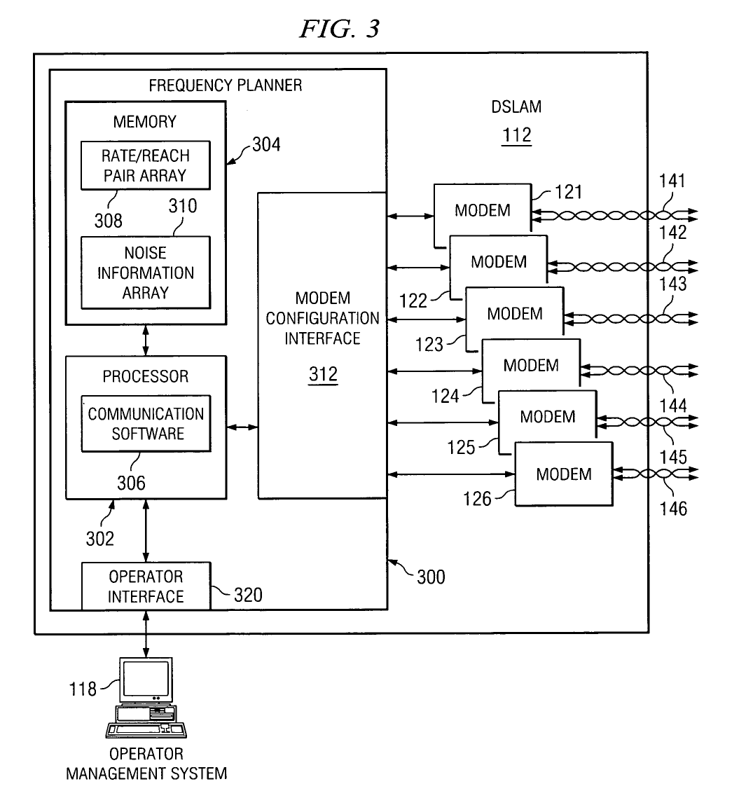

FIG. 3 illustrates a frequency planner 300 configured in accordance with a preferred embodiment of the invention. Frequency planner 300 preferably comprises a processor 302, a memory 304, a modem interface 312, and an operator interface 320. Memory 304 couples to processor 302 and comprises rate/reach pair array 308 and noise information array 310. Each element of rate/reach pair array 308 corresponds to a service target that may be input via operator interface 320. Each element in the rate/reach array 308 comprises a length, a downstream bit rate, and an upstream bit rate. Noise information array 310 comprises information about noise on the twisted-pair lines 141 through 146. The noise information could be supplied by the modems 121 through 126 via modem interface 312, or it could be communicated from the operator management system 118 through the operator interface 320.

Communication software 306 executes on processor 302. The communication software 306 accesses the rate/reach pair array 308. Processor 302 also couples to operator interface 320 which may be coupled to an operator management system 118. An operator may use the operator management system 118 to configure the frequency planner 300 (e.g., to configure the rate/reach pair array 308). The operator management system 118 may also be used to receive notification messages from the frequency planner 300 (e.g., error messages). Processor 302 also couples to modem interface 312. Communication software 306 may send and receive digital data via modem interface 312.

In accordance with at least some of the embodiments, the communication software 306 causes the processor 302 to configure the modems 121 through 126 to communicate using specific upstream and downstream bands, as well as to configure the modems at the other end of each twisted pair 141 through 146 (not shown). This permits the modems at each end of each line to operate more efficiently given the target service requirements in rate/reach pair array 308. Such an approach may be used when the DSL installation does not require the use of a standardized frequency plan (e.g., in a private distribution system or a distribution system where the service provider is not required to unbundle its services).

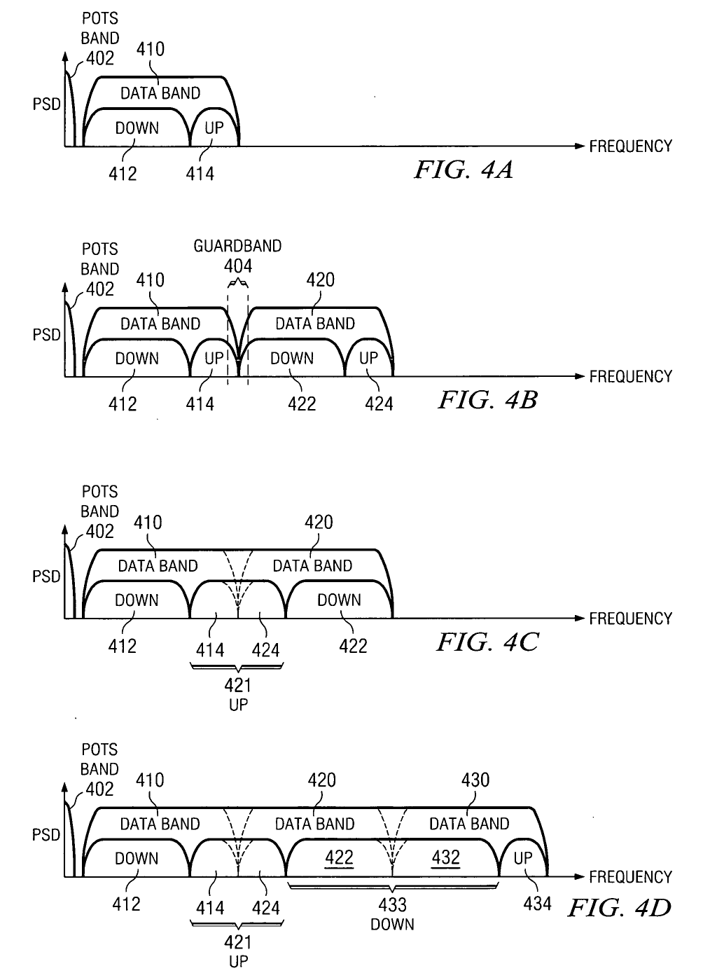

FIGS. 4A through 4D illustrate how data communication system 300 may configure a frequency plan in an iterative fashion by defining multiple bands. This method may provide better utilization of the available bandwidth for multiple twisted pairs within a wire bundle than the utilization provided by a standardized frequency plan. Data bands comprising at least one upstream and one downstream band are iteratively selected from the rate/reach pair array 308. Each element of the array comprises the length of a twisted pair (reach) within the wire bundle and the target downstream and upstream data rates for that twisted pair. The rate/reach pair array elements are processed in order, starting with the rate/reach pair with the longest reach (having the greatest bandwidth restrictions) and ending with the rate/reach pair with the shortest reach (having the least bandwidth restrictions).

FIG. 4A illustrates a first data band 410 comprising an upstream band 414 and a downstream band 412. In accordance with at least some embodiments, the first data band 410 is configured such that data may be transmitted at the target upstream and downstream data rates of the rate/reach pair element with the longest reach. Data band 410 may reside above the plain old telephone service (POTS) band 402 to reduce interference between the two systems (i.e., data and voice communication systems). FIG. 4B illustrates the first data band 410 combined with a second data band 420. Data band 420 comprises an upstream band 424 and a downstream band 422. The bandwidths of the downstream band 422 and upstream band 424 in the second data band 420 are configured such that the combination of the data bands 410 and 420 allows data to be transmitted at the target data rate of the rate/reach pair element with the second longest reach, as well as at the target data rate of the rate/reach pair element with the longest reach.

As illustrated in FIG. 4B, a certain amount of bandwidth may not be usable due to the need for a guardband 404 used to separate signals in adjacent upstream and downstream bands (to reduce interference between the bands). For example, a guardband might be necessary to separate downstream band 422 and upstream band 414 in FIG. 4B. Guardbands reduce the bandwidth that is available for data transmission. FIG. 4C illustrates an alternative arrangement of the upstream and downstream bands within data band 420 that improves the efficiency of the frequency plan. This arrangement eliminates the need for guardband 404 and creates a consolidated upstream band 421 by combining upstream bands 414 and 424 into a single continuous band. This configuration permits additional efficiency gains in bandwidth utilization.

FIG. 4D illustrates how successive bands may be added to increase the available bandwidth for additional rate/reach pairs. A third data band 430 is shown with additional bandwidth added to allow data to be transmitted at the target data rate of the rate/reach pair element with the next longest twisted pair (shorter than the previous twisted pair). This third data band 430 may also be configured to avoid the need for a guardband between the upstream and downstream bands of adjacent data bands. Consolidating downstream bands 422 and 432 creates consolidated downstream band 433.

Referring once again to the preferred embodiment of FIG. 1, the frequency planner 300 within the local exchange 110 may perform the calculations and assignment of bands, and then communicate this information to both the modem 121 (locally) and the modem/router 134 at the subscriber location 130 (using a default band configuration). After the modem 121 and the modem/router 134 have the optimized frequency plan, both devices may begin operating using the optimized frequency plan. This allows the DSL service provider to control the overall configuration of all data communication systems and update the rate/reach pairs to reflect the desired configuration and current conditions of the DSL installation 100.

Updates to the configuration of the rate/reach pairs may be in response to changes in conditions noted by an operator of the DSL installation 100. Updates may also be made in response to conditions detected by either the modem 121 or the modem/router 134 and communicated to an operator on the operator management system 118. Such conditions may include noise changes, line degradation due to damage, and interference from external sources (e.g., a radio transmitter outside the DSL installation 100). When such conditions arise, the operator may alter the rate/reach pair configuration and command the data communication systems coupled with twisted pairs that share a wire bundle to reconfigure themselves using the updated parameters.

FIG. 5 illustrates a method 500 for configuring a frequency plan in accordance with at least some embodiments of the invention. The rate/reach pair array element with the longest reach is read as shown in block 502. Block 504 begins an iterative process that comprises blocks 504 through 510. In block 504 at least one upstream band and one downstream band are defined, based on the data rates of the rate/reach pair most recently read, and are appended to the frequency plan. Other factors that may also be considered in defining the upstream and downstream bands include the number of carriers defined within the bands, the modulation type used to encode the data on the carriers, and noise levels on the twisted pair.

Block 508 determines if the last rate/reach pair has been read. If the last pair has not been read, another iteration is executed and another rate/reach pair is read as shown in block 510. The rate/reach pair selected in block 510 is the rate/reach pair with the longest reach that is also shorter than the reach of the rate/reach pair just processed in block 504. The process is then repeated for subsequently read rate/reach pairs until all pairs have been processed.

One function of block 504 is to determine if it is possible to define a frequency plan, constrained by the results of previous iterations, that allows data to be transmitted at the data rates and reach specified by the current rate/reach pair. This determination is performed by evaluating various factors including total bandwidth, reach, noise levels (which may be measured or estimated by the modems or input by the operator through the operator interface 320), number of carriers, and modulation types used. For example, noise levels on the twisted pair may prevent certain carrier frequencies from being used, resulting in the need to use other carrier frequencies that can result in an increase in the total bandwidth requirement for the DSL signal. If the total bandwidth required to support the target exceeds the maximum usable frequency of the twisted pair (determined by its length, noise levels, power spectrum constraints, and other factors), the target data rate stored in the rate/reach pair will not be attainable.

When it is determined in block 506 that a frequency plan could not be found in block 504 that allows data transmission at the data rate of the matched rate/reach pair, a frequency plan error is generated as shown in block 512 and processing is ended. If block 504 does find a frequency plan that allows data transmission at the data rate of the matched rate/reach pair data rate, the frequency plan is valid and the iterative process continues. After all rate/reach pairs have been successfully processed, the frequency plan is sent to the DSLAM modems as shown in block 514, completing the configuration as shown in block 516.

The above disclosure is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

1. An iterative method used in a data communication system, comprising:
selecting a target data rate and a target loop length (rate/reach target) from a plurality of rate/reach targets;
defining a frequency plan that supports the selected rate/reach target; and
aggregating the defined frequency plan into an overall frequency plan;
wherein the selecting, defining and aggregating are performed in each of multiple iterations within a cycle; and
wherein at the end of an iteration the overall frequency plan permits transmission of data at the target data rate stored in the rate/reach target selected in the iteration.

2. The method of claim 1, further comprising stopping the iterations after the last rate/reach target of the plurality of rate/reach targets has been selected.

3. The method of claim 1, further comprising stopping the iterations if the overall frequency plan fails to permit the target data rate stored in the selected rate/reach target.

4. The method of claim 1, wherein defining the frequency plan comprises defining the frequency plan based on a noise level.

5. The method of claim 1, wherein defining the frequency plan comprises defining the frequency plan based on an allowed transmission power level.

6. The method of claim 1, further comprising:
dividing a spectral band into an upstream band and a downstream band;
wherein the upstream band is spectrally adjacent to at least one other upstream band within another spectral band; and
wherein the dividing of the spectral band is governed by the frequency plan.

7. The method of claim 1, further comprising:
dividing a spectral band into an upstream band and a downstream band;
wherein the downstream band is spectrally adjacent to at least one other downstream band within another spectral band; and
wherein the dividing of the spectral band is governed by the frequency plan.

8. A data communication system, comprising:
a processor; and
communication software executing on the processor, the communication software causing the processor to iteratively select a target data rate and a target loop length (rate/reach target) from a plurality of rate/reach targets, and to iteratively define a frequency plan that is incorporated into an overall frequency plan;
wherein the overall frequency plan that results at the end of an iteration allows transmission of data at the target data rate stored in the rate/reach target selected within the current iteration.

9. The data communication system of claim 8, wherein the communication software causes the processor to stop performing iterations after the last rate/reach target of the plurality of rate/reach targets is selected.

10. The data communication system of claim 8, wherein the communication software causes the processor to stop performing iterations if the overall frequency plan fails to permit the data rate stored in the selected rate/reach target

11. The data communication system of claim 8, further comprising:
a communication interface adapted to provide a communication link to at least one other data communication system, the communication interface coupled to the at least one other data communication system by a wire having a length;
wherein the length of the wire matches a reach stored in at least one of the plurality of rate/reach pairs.

12. The data communication system of claim 11, wherein communications with the at least one other data communications system occurs at least at the target data rate stored in the at least one of the plurality of rate/reach pairs.

13. The data communication system of claim 8, wherein the communication software causes the processor to iteratively define the frequency plan based on a noise level.

14. The data communication system of claim 8, wherein the communication software causes the processor to iteratively define the frequency plan based on a distribution of carrier frequencies.

15. The data communication system of claim 8, wherein the communication software causes the processor to iteratively define the frequency plan based on a modulation type used to modulate carrier frequencies.

16. The data communication system of claim 8, wherein the communication software causes the processor to iteratively define the frequency plan based on an allowed transmission power level.

17. A storage medium containing software that can be executed on a processor and that causes the processor to iteratively:
select a target data rate and a target wire length (rate/reach target) from a plurality of rate/reach targets;
define a frequency plan; and
aggregate the defined frequency plan into an overall frequency plan;
wherein the processor selects, defines and aggregates in each of multiple iterations; and
wherein at the end of an iteration the overall frequency plan allows data to be transmitted at the target data rate stored in the rate/reach pair selected in the iteration.

18. The storage medium of claim 17, wherein the software further causes the processor to stop the iterations after the last rate/reach target of the plurality of rate/reach targets has been selected.

19. The storage medium of claim 17, wherein the software further causes the processor to stop the iterations if the overall frequency plan fails to permit the target data rate stored in the selected rate/reach target.

20. The storage medium of claim 17, wherein defining the frequency plan comprises defining the frequency plan based on a distribution of carrier frequencies.

21. The storage medium of claim 17, wherein defining the frequency plan comprises defining the frequency plan based on a modulation type used to modulate carrier frequencies.

22. The storage medium of claim 17,
wherein the software further causes the processor to divide a spectral band into an upstream band and a downstream band, the division controlled by the frequency plan; and
wherein the upstream band is combined with an adjacent upstream band within another spectral band.

23. The storage medium of claim 17,
wherein the software further causes the processor to divide a spectral band into an upstream band and a downstream band, the division controlled by the frequency plan; and
wherein the downstream band is combined with an adjacent downstream band within another spectral band.
